(19) United States
(12) Patent Application Publication
(10) Pub. No.: US 2008/0074509 A1
(43) Pub. Date: Mar. 27, 2008

(54) Image pickup device

(76) Inventor: Akira Sano, Kanagawa (JP)

Correspondence Address: FROMMER LAWRENCE & HAUG LLP, 745 FIFTH AVENUE, NEW YORK, NY, 10151, US

(21) Appl. No.: 11/903,920

(22) Filed: Sep. 25, 2007

(30) Foreign Application Priority Data
Sep. 27, 2006 (JP) P2006-262734

(51) Int. Cl. H04N 5/76

(52) U.S. Cl. 348/231.3

(57) ABSTRACT

An image pickup device includes a lens-barrel block having a lens barrel in which a predetermined lens is disposed, an image pickup block having an image pickup element that converts a light signal of a subject taken in through the lens-barrel block into an image signal, a circuit block having a circuit substrate that at least processes the image signal, and a recording block that records the image signal. When a side of the device that is proximate to the subject is defined as a front side of the device, the image pickup block and the circuit block are arranged adjacent to each other in a front-rear direction of the device, and the recording block is disposed adjacent to the image pickup block and the circuit block in a direction substantially perpendicular to the direction in which the image pickup block and the circuit block are arranged.

### CROSS REFERENCES TO RELATED APPLICATIONS

The present invention contains subject matter related to Japanese Patent Application JP 2006-262734 filed in the Japanese Patent Office on Sep. 27, 2006, the entire contents of which are incorporated herein by reference.

### BACKGROUND OF THE INVENTION

1. Field of the Invention

The present invention relates to image pickup devices, and particularly, to an image pickup device in which the arrangement of blocks included therein are improved so that the device can be reduced in dimension in the front-rear direction thereof.

2. Description of the Related Art

Image pickup devices, such as video cameras, are used for various purposes and therefore include various types, such as a general-purpose type used domestically for shooting various kinds of images, and professional types used in, for example, the film industry and the media industry.

Japanese Unexamined Patent Application Publication No. 2001-53994 discloses an example of an image pickup device equipped with predetermined blocks, such as a lens-barrel block having a lens barrel in which a predetermined lens is disposed, an image pickup block having an image pickup element, a circuit block having a circuit substrate, and a recording block having a drive mechanism for driving a recording medium and also having a semiconductor storage medium so as to record image signals.

FIG. 15 illustrates an image pickup device e of related art. In the image pickup device e, an image pickup block b is disposed adjacently behind a lens-barrel block a, and a circuit block c and a recording block d are arranged adjacent to each other in the left-right direction behind the image pickup block b.

### SUMMARY OF THE INVENTION

Because the lens-barrel block a and the image pickup block b are arranged in the front-rear direction, and the circuit block c and the recording block d are located behind these blocks a and b, the image pickup device e is long in the front-rear direction. This can be problematic when the image pickup device e is used for a long period of time.

When filming a movie, for example, there are cases where the filming takes place in a small space. In such cases, the user may be inconvenienced by the large length of the device in the front-rear direction, which can cause difficulty in the filming process.

When the image pickup device is used for media purposes, there are often cases where the user uses the device by carrying the device on his/her shoulder in a space crowded with people. In such cases, there may be problems where the front and rear end portions of the device come into contact with others or others' image pickup devices in front of or behind the user.

Accordingly, it is desirable to provide an image pickup device that is reduced in dimension in the front-rear direction thereof.

According to an embodiment of the present invention, there is provided an image pickup device that includes a lens-barrel block having a lens barrel in which a predetermined lens is disposed, an image pickup block having an image pickup element that converts a light signal of a subject taken in through the lens-barrel block into an image signal, a circuit block having a circuit substrate that at least processes the image signal, and a recording block that records the image signal. When a side of the device that is proximate to the subject is defined as a front side of the device, the image pickup block and the circuit block are arranged adjacent to each other in a front-rear direction of the device, and the recording block is disposed adjacent to the image pickup block and the circuit block in a direction substantially perpendicular to the direction in which the image pickup block and the circuit block are arranged.

If the image pickup device has a specification in which a battery is to be mounted in a range between the front end of the image pickup block and the rear end or rear side of the circuit block, the recording block is located in an area within the rear end of the battery.

Accordingly, the overall length in the front-rear direction of the device can be reduced so that the problem where the user is inconvenienced by a large length in the front-rear direction during a photographing operation can be solved. Accordingly, this allows for better usability of the image pickup device for a photographing operation.

The recording block may be disposed adjacently to a left side or right side of the image pickup block and the circuit block. Thus, a position most appropriate for each of the blocks can be selected for its intended purpose in accordance with the size and feature of the block.

Alternatively, the recording block may be disposed adjacently above or below the image pickup block and the circuit block. Thus, a position most appropriate for each of the blocks can be selected for its intended purpose in accordance with the size and feature of the block.

Furthermore, the circuit block may have a cooling fan disposed therein for cooling the circuit substrate. In that case, the cooling fan has a rotary shaft whose axial direction extends substantially perpendicular to a direction in which a component-mount surface of the circuit substrate is faced. This allows ambient air to flow along the circuit substrate, thereby enhancing the cooling efficiency.

### BRIEF DESCRIPTION OF THE DRAWINGS

FIG. 1 illustrates a first embodiment of the present invention together with FIGS. 2 to 12, and is a schematic perspective view of an image pickup device according to the first embodiment;

FIG. 2 is a schematic rear view of the image pickup device;

FIG. 3 is a schematic side view illustrating a case where a cooling fan is disposed at the rear side of the image pickup device;

FIG. 4 is a schematic rear view illustrating the case where the cooling fan is disposed at the rear side of the image pickup device;

FIG. 5 is a schematic side view illustrating a case where the cooling fan is disposed at the upper side of the image pickup device;

FIG. 6 is a schematic rear view illustrating the case where the cooling fan is disposed at the upper side of the image pickup device;

FIG. 7 illustrates an image pickup device according to a first modified example together with FIG. 8, and is a schematic side view of the image pickup device;

FIG. 8 is a schematic rear view of the image pickup device;

FIG. 9 illustrates an image pickup device according to a second modified example together with FIG. 10, and is a schematic side view of the image pickup device;

FIG. 10 is a schematic rear view of the image pickup device;

FIG. 11 illustrates an image pickup device according to a third modified example together with FIG. 12, and is a schematic side view of the image pickup device;

FIG. 12 is a schematic rear view of the image pickup device;

FIG. 13 illustrates a second embodiment of the present invention together with FIG. 14, and is a schematic perspective view of an image pickup device according to the second embodiment;

FIG. 14 is a schematic rear view of the image pickup device; and

FIG. 15 is a schematic perspective view showing an example of an image pickup device of related art.

### DESCRIPTION OF THE PREFERRED EMBODIMENTS

Preferred embodiments of the present invention will now be described with reference to the drawings.

An image pickup device according to each of the preferred embodiments of the present invention to be described below is directed to a video camera. However, the technical scope of the invention is not limited to a video camera. For example, the present invention is also applicable to still cameras or other types of image pickup devices that pick up images including video images.

In the description below, the terms related to directions, such as “front”, “rear”, “forward”, “rearward”, “upward”, “downward”, “upper”, “lower”, “vertical”, “left”, and “right”, are used as viewed from the point of the photographer, i.e. the user, when the photographer performs a photographing operation using the video camera. This implies that a front side is the side closer to a subject, whereas a rear side is the side closer to the photographer. The terms related to the directions are used only for the sake of convenience of the description below. Therefore, in the embodiments of the present invention, the directions are not limited to those written above.

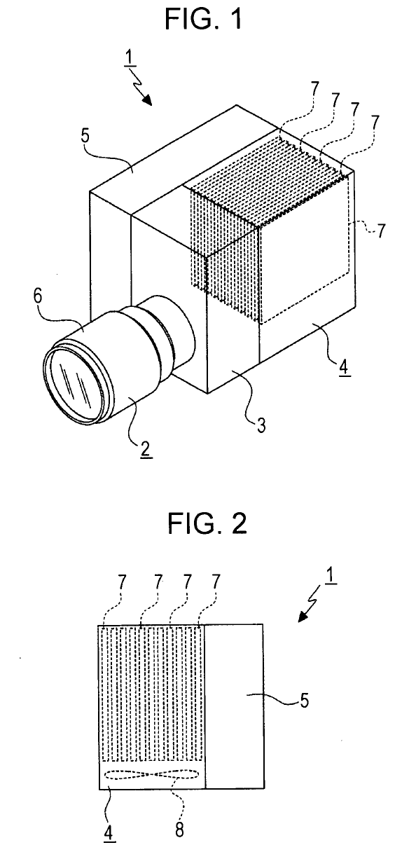

A first embodiment of the present invention will be described with reference to FIGS. 1 to 12.

Referring to FIG. 1, an image pickup device (i.e. video camera) 1 includes a lens-barrel block 2, an image pickup block 3, a circuit block 4, and a recording block 5. The image pickup device 1 is also provided with a viewfinder (not shown).

The lens-barrel block 2 includes a lens barrel 6 in which a predetermined lens is disposed.

The image pickup block 3 includes an image pickup element that converts a light signal of a subject taken in through the lens-barrel block 2 into an image signal. The image pickup block 3 is disposed adjacent to the rear side of the lens-barrel block 2.

The circuit block 4 accommodates a plurality of circuit substrates 7 arranged therein and a cooling fan 8.

Each circuit substrate 7 has, for example, a control circuit and a signal processing circuit, and performs various control operations, such as driving of the recording block 5 and processing of the image signal generated by the image pickup element. For example, the circuit substrates 7 are arranged separately from each other in the left-right direction such that component-mount surfaces thereof are faced in the left-right direction.

The cooling fan 8 has a function of suppressing an increase in temperature caused by heat generated from various electronic components mounted on the circuit substrates 7. Referring to FIG. 2, the cooling fan 8 is, for example, an exhaust fan and is disposed below the circuit substrates 7 such that a rotary shaft of the cooling fan 8 extends in the vertical direction.

The circuit block 4 has an exhaust hole (not shown) in the lower surface thereof, and also has an intake hole (not shown) in the rear surface or upper surface thereof.

The recording block 5 includes a semiconductor storage medium (not shown), such as a drive mechanism and a memory, for driving a recording medium on which image signals are recorded. The recording medium may be, for example, a tape recording medium, a disc recording medium, or a card recording medium. The recording block 5 is disposed adjacently to the right of the image pickup block 3 and the circuit block 4.

In the image pickup device 1 having the above-described configuration, when each of the units is actuated for a photographing operation, for example, so as to cause the various electronic components mounted on the circuit substrates 7 to generate heat, ambient air is taken in through the intake hole provided in the rear surface, the upper surface, or the vicinity of these surfaces of the circuit block 4. The ambient air serves as cooling air, and flows forward or downward along the circuit substrates 7. The air then flows further downward where the cooling fan 8 discharges the air outward through the exhaust hole provided in the lower surface of the circuit block 4. In this manner, the internal temperature of the circuit block 4 can be prevented from increasing.

As mentioned above, the axial direction of the rotary shaft of the cooling fan 8 extends vertically, such that this axial direction is perpendicular to (namely, substantially perpendicular to) the left-right direction, which is the direction in which the component-mount surfaces of the circuit substrates 7 are faced. Thus, the ambient air can flow along the circuit substrates 7, thereby enhancing the cooling efficiency.

Although the recording block 5 is disposed adjacently to the right of the image pickup block 3 and the circuit block 4 in the above description, the recording block 5 may alternatively be disposed adjacently to the left of the image pickup block 3 and the circuit block 4.

As described above, in the image pickup device 1, the image pickup block 3 and the circuit block 4 are disposed adjacent to each other in the front-rear direction, and the recording block 5 is disposed adjacently to the right or left of the image pickup block 3 and the circuit block 4. This configuration can reduce the overall length in the front-rear direction so that the problem where the photographer is inconvenienced by a large length in the front-rear direction during a photographing operation can be solved. Accordingly, this allows for better usability of the image pickup device 1 for a photographing operation.

Because the recording block 5 is disposed adjacently to the left or right of the image pickup block 3 and the circuit block 4, the width of the circuit block 4 in the left-right direction can be increased in accordance with the width of the image pickup block 3 in the left-right direction. This enables a large-size cooling fan 8 to be disposed in the circuit block 4, thus allowing a sufficient volume of cooling air to be attained with the cooling fan 8 rotating at low speed. Accordingly, this can reduce noise frequency and noise level, thereby achieving noise reduction.

Although the cooling fan 8 is used as an exhaust fan in the above description, the cooling fan 8 may alternatively be used as an intake fan. In that case, the intake hole is located in the lower surface of the circuit block 4, and the exhaust hole is located in the rear surface, the upper surface, or the vicinity of these surfaces of the circuit block 4.

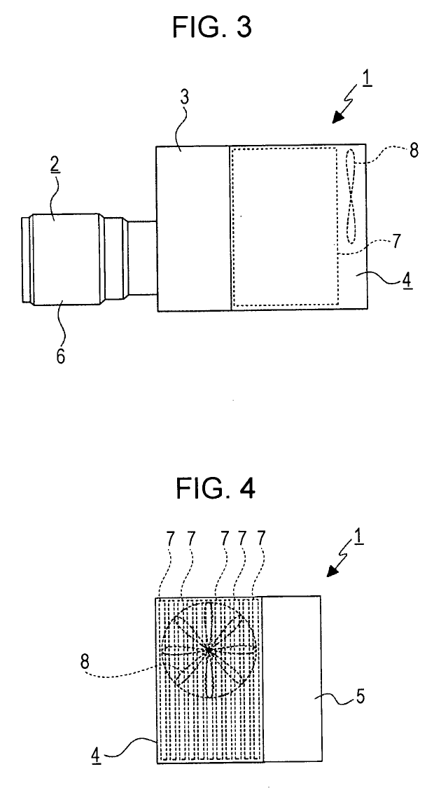

Referring to FIGS. 3 and 4, the cooling fan 8 may alternatively be disposed behind the circuit substrates 7 such that the rotary shaft of the cooling fan 8 extends in the front-rear direction. In that case, if the cooling fan 8 is used as an exhaust fan, the intake hole is located at a forward section on the lower surface or a forward section on the upper surface of the circuit block 4, and the exhaust hole is located in the rear surface of the circuit block 4. If the cooling fan 8 is used as an intake fan, the intake hole is located in the rear surface of the circuit block 4, and the exhaust hole is located at a forward section on the lower surface or a forward section on the upper surface of the circuit block 4.

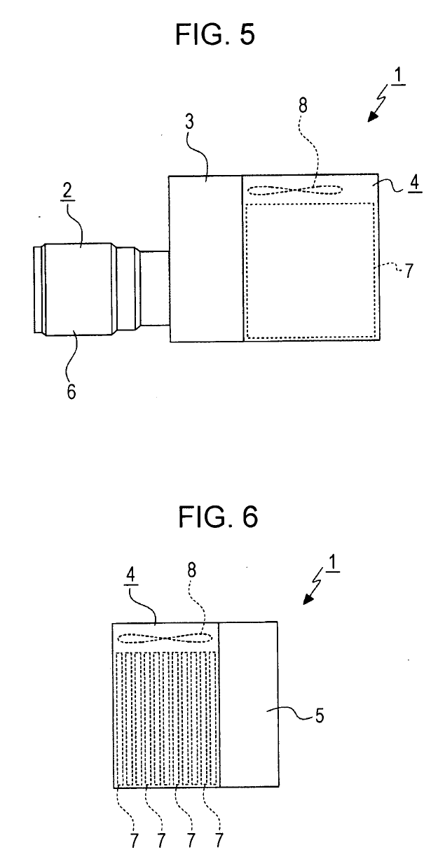

Referring to FIGS. 5 and 6, the cooling fan 8 may alternatively be disposed above the circuit substrates 7 such that the rotary shaft of the cooling fan 8 extends in the vertical direction. In that case, if the cooling fan 8 is used as an exhaust fan, the intake hole is located at a lower section of the rear surface, a lower section of the front surface, or the lower surface of the circuit block 4, and the exhaust hole is located in the upper surface or the vicinity thereof. If the cooling fan 8 is used as an intake fan, the intake hole is located in the upper surface of the circuit block 4, and the exhaust hole is located at a lower section of the rear surface, a lower section of the front surface, or the lower surface of the circuit block 4.

In the above-described case where the cooling fan 8 is disposed above the circuit substrates 7 and is used as an exhaust fan in particular, the increased-temperature air in the circuit block 4 can move upward readily. Thus, the air can be discharged readily through the exhaust hole in the upper surface of the circuit block 4, thereby enhancing the cooling efficiency.

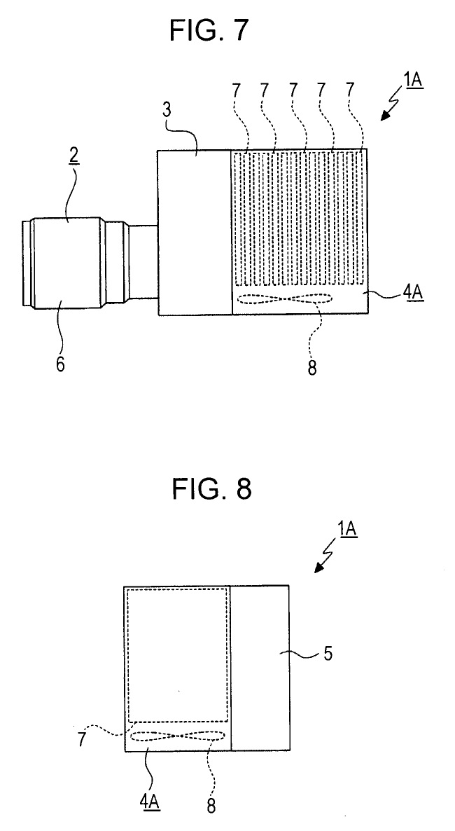

Modified examples of the image pickup device 1 will now be described with reference to FIGS. 7 to 12.

The modified examples to be described below do not differ in arrangement of the lens-barrel block, the image pickup block, the circuit block, and the recording block from that in the image pickup device 1 described above. The modified examples only differ from the image pickup device 1 in the orientation of the circuit substrates and the cooling fan disposed within the circuit block. Therefore, the description below will only be directed to components that are different from those in the image pickup device 1. The remaining components in the modified examples that are the same as those in the image pickup device 1 are given the same reference numerals, and descriptions of those components will not be repeated.

FIGS. 7 and 8 illustrate an image pickup device 1A according to a first modified example. The image pickup device 1A includes a circuit block 4A in which the circuit substrates 7 are arranged separately from each other in the front-rear direction such that the circuit substrates 7 are faced in the front-rear direction.

The cooling fan 8 is, for example, an exhaust fan and is disposed below the circuit substrates 7 such that the rotary shaft of the cooling fan 8 extends in the vertical direction.

The circuit block 4A has an exhaust hole (not shown) in the lower surface thereof, and also has an intake hole (not shown) in the upper surface thereof or the vicinity of the upper surface.

In the image pickup device 1A having the above-described configuration, when each of the units is actuated for a photographing operation, for example, so as to cause the various electronic components mounted on the circuit substrates 7 to generate heat, ambient air is taken in through the intake hole provided in the upper surface of the circuit block 4A or the vicinity of the upper surface. The ambient air serves as cooling air, and flows rightward or downward along the circuit substrates 7. The air then flows further downward where the cooling fan 8 discharges the air outward through the exhaust hole provided in the lower surface of the circuit block 4A. In this manner, the internal temperature of the circuit block 4A can be prevented from increasing.

In the image pickup device 1A, the recording block 5 may be disposed adjacently to the left of the image pickup block 3 and the circuit block 4.

In a case where the cooling fan 8 is used as an intake fan in the image pickup device 1A, the intake hole is located in the lower surface of the circuit block 4A, and the exhaust hole is located in the upper surface of the circuit block 4A or the vicinity of the upper surface.

In a case where the recording block 5 is disposed to the right of the circuit block 4A in the image pickup device 1A, the cooling fan 8 can be disposed to the left of the circuit substrates 7 such that the rotary shaft of the cooling fan 8 extends in the left-right direction. In contrast, in a case where the recording block 5 is disposed to the left of the circuit block 4A, the cooling fan 8 can be disposed to the right of the circuit substrates 7 such that the rotary shaft of the cooling fan 8 extends in the left-right direction. In either of these cases, if the cooling fan 8 is used as an exhaust fan, the intake hole is located in the lower surface, the upper surface, or the rear surface of the circuit block 4A, and the exhaust hole is located in the left or right side surface of the circuit block 4A. If the cooling fan 8 is used as an intake fan, the intake hole is located in the left or right side surface of the circuit block 4A, and the exhaust hole is located in the lower surface, the upper surface, or the rear surface of the circuit block 4A.

Alternatively, the cooling fan 8 may be disposed above the circuit substrates 7 such that the rotary shaft of the cooling fan 8 extends in the vertical direction. In that case, if the cooling fan 8 is used as an exhaust fan, the intake hole is located in the lower surface of the circuit block 4A or the vicinity of the lower surface, and the exhaust hole is located in the upper surface of the circuit block 4A or the vicinity of the upper surface. If the cooling fan 8 is used as an intake fan, the intake hole is located in the upper surface of the circuit block 4A or the vicinity of the upper surface, and the exhaust hole is located in the lower surface of the circuit block 4A or the vicinity of the lower surface.

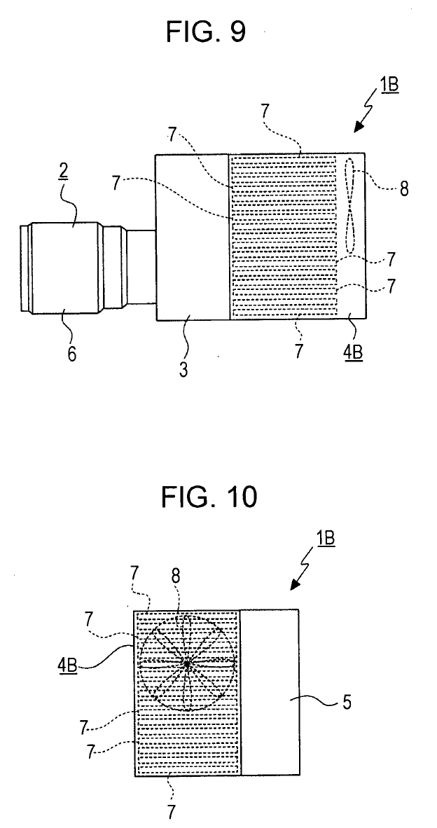

FIGS. 9 and 10 illustrate an image pickup device 1B according to a second modified example. The image pickup device 1B includes a circuit block 4B in which the circuit substrates 7 are arranged separately from each other in the vertical direction such that the circuit substrates 7 are faced in the vertical direction.

The cooling fan 8 is, for example, an exhaust fan and is disposed behind the circuit substrates 7 such that the rotary shaft of the cooling fan 8 extends in the front-rear direction.

The circuit block 4B has an exhaust hole (not shown) in the rear surface thereof, and also has an intake hole (not shown) in a forward section on the left side surface thereof.

In the image pickup device 1B having the above-described configuration, when each of the units is actuated for a photographing operation, for example, so as to cause the various electronic components mounted on the circuit substrates 7 to generate heat, ambient air is taken in through the intake hole provided in the forward section on the left side surface of the circuit block 4B. The ambient air serves as cooling air, and flows along the circuit substrates 7. The air then flows rearward where the cooling fan 8 discharges the air outward through the exhaust hole provided in the rear surface of the circuit block 4B. In this manner, the internal temperature of the circuit block 4B can be prevented from increasing.

In the image pickup device 1B, the recording block 5 may be disposed adjacently to the left of the image pickup block 3 and the circuit block 4.

In a case where the cooling fan 8 is used as an intake fan in the image pickup device 1B, the intake hole is located in the rear surface of the circuit block 4B, and the exhaust hole is located in one of a forward section on the left side surface, the upper surface, and the lower surface of the circuit block 4B.

In a case where the recording block 5 is disposed to the right of the circuit block 4B in the image pickup device 1B, the cooling fan 8 can be disposed to the left of the circuit substrates 7 such that the rotary shaft of the cooling fan 8 extends in the left-right direction. In contrast, in a case where the recording block 5 is disposed to the left of the circuit block 4B, the cooling fan 8 can be disposed to the right of the circuit substrates 7 such that the rotary shaft of the cooling fan 8 extends in the left-right direction. In either of these cases, if the cooling fan 8 is used as an exhaust fan, the intake hole is located in the lower surface, the upper surface, or the rear surface of the circuit block 4B, and the exhaust hole is located in the left or right side surface of the circuit block 4B. If the cooling fan 8 is used as an intake fan, the intake hole is located in the left or right side surface of the circuit block 4B, and the exhaust hole is located in the lower surface, the upper surface, or the rear surface of the circuit block 4B.

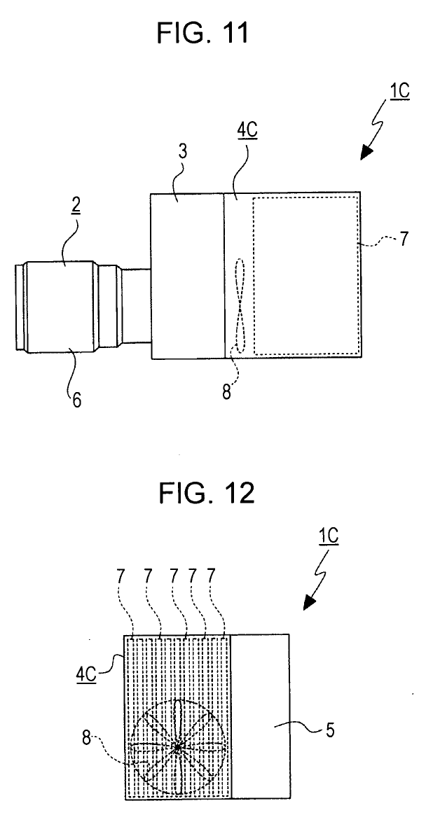

FIGS. 11 and 12 illustrate an image pickup device 1C according to a third modified example. The image pickup device 1C includes a circuit block 4C in which the circuit substrates 7 are arranged separately from each other in the left-right direction such that the component-mount surfaces thereof are faced in the left-right direction.

The cooling fan 8 is, for example, an exhaust fan and is disposed in front of the circuit substrates 7 such that the rotary shaft of the cooling fan 8 extends in the front-rear direction.

The circuit block 4C has an intake hole (not shown) in the rear surface, the upper surface, or the lower surface thereof, and also has an exhaust hole (not shown) in at least one of a forward-end section on the lower surface, a forward-end section on the upper surface, and a forward section on the left side surface of the circuit block 4C.

In the image pickup device 1C having the above-described configuration, when each of the units is actuated for a photographing operation, for example, so as to cause the various electronic components mounted on the circuit substrates 7 to generate heat, ambient air is taken in through the intake hole provided in the rear surface, the upper surface, or the lower surface of the circuit block 4C. The ambient air serves as cooling air, and flows forward along the circuit substrates 7. The cooling fan 8 then discharges the air outward through the exhaust hole provided in at least one of the forward-end section on the lower surface, the forward-end section on the upper surface, and the forward section on the left side surface of the circuit block 4C. In this manner, the internal temperature of the circuit block 4C can be prevented from increasing.

In the image pickup device 1C, the recording block 5 may be disposed adjacently to the left of the image pickup block 3 and the circuit block 4.

In a case where the cooling fan 8 is used as an intake fan in the image pickup device 1C, the intake hole is located in at least one of a forward-end section on the lower surface, a forward-end section on the upper surface, and a forward-end section on a side surface of the circuit block 4C, and the exhaust hole is located in the rear surface, the upper surface, or the lower surface of the circuit block 4C.

In the image pickup device 1C, the circuit substrates 7 may alternatively be arranged separately from each other in the vertical direction such that the component-mount surfaces thereof are faced in the vertical direction. In that case, if the cooling fan 8 is used as an exhaust fan, the exhaust hole is located in at least one of a forward-end section on the lower surface, a forward-end section on the upper surface, and a forward-end section on a side surface of the circuit block 4C, and the intake hole is located in the rear surface or the left or right side surface of the circuit block 4C. If the cooling fan 8 is used as an intake fan, the exhaust hole is located in the rear surface or the left or right side surface of the circuit block 4C, and the intake hole is located in at least one of a forward-end section on the lower surface, a forward-end section on the upper surface, and a forward-end section on a side surface of the circuit block 4C.

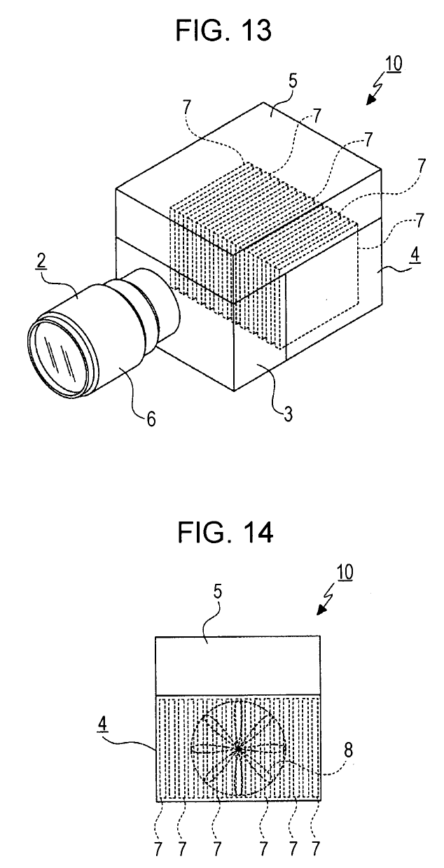

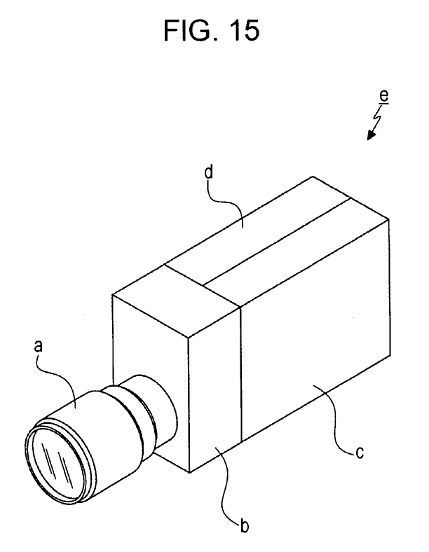

A second embodiment will now be described with reference to FIGS. 13 and 14.

An image pickup device 10 according to the second embodiment does not differ in arrangement of the lens-barrel block, the image pickup block, and the circuit block from that in the image pickup device 1 described above. The image pickup device 10 only differs from the image pickup device 1 in the positioning of the recording block. Therefore, the description below will only be directed to components that are different from those in the image pickup device 1. The remaining components in the image pickup device 10 that are the same as those in the image pickup device 1 are given the same reference numerals, and descriptions of those components will not be repeated.

Referring to FIG. 13, in the image pickup device 10, the recording block 5 is disposed adjacently above the image pickup block 3 and the circuit block 4.

Referring to FIG. 14, the circuit substrates 7 in the circuit block 4 are arranged separately from each other in the left-right direction such that the component-mount surfaces thereof are faced in the left-right direction. The cooling fan 8 is, for example, an exhaust fan and is disposed behind the circuit substrates 7 such that the rotary shaft of the cooling fan 8 extends in the front-rear direction.

The circuit block 4 has an exhaust hole (not shown) in the rear surface thereof, and also has an intake hole (not shown) in the lower surface thereof.

In the image pickup device 10 having the above-described configuration, when each of the units is actuated for a photographing operation, for example, so as to cause the various electronic components mounted on the circuit substrates 7 to generate heat, ambient air is taken in through the intake hole provided in the lower surface of the circuit block 4. The ambient air serves as cooling air, and flows along the circuit substrates 7. The air then flows rearward where the cooling fan 8 discharges the air outward through the exhaust hole provided in the rear surface of the circuit block 4. In this manner, the internal temperature of the circuit block 4 can be prevented from increasing.

As described above, the axial direction of the rotary shaft of the cooling fan 8 is aligned with the front-rear direction and extends substantially perpendicular to the left-right direction, which is the direction in which the component-mount surfaces of the circuit substrates 7 are faced. Thus, the ambient air can flow along the circuit substrates 7, thereby enhancing the cooling efficiency.

Although the recording block 5 is disposed adjacently above the image pickup block 3 and the circuit block 4 in the above description, the recording block 5 may alternatively be disposed adjacently below the image pickup block 3 and the circuit block 4.

As described above, in the image pickup device 10, the image pickup block 3 and the circuit block 4 are disposed adjacent to each other in the front-rear direction, and the recording block 5 is disposed adjacently above or below the image pickup block 3 and the circuit block 4. This configuration can reduce the overall length in the front-rear direction so that the problem where the photographer is inconvenienced by a large length in the front-rear direction during a photographing operation can be solved. Accordingly, this allows for better usability of the image pickup device 10 for a photographing operation.

Because the recording block 5 can be disposed above the image pickup block 3 and the circuit block 4, the width of the circuit block 4 in the left-right direction can be increased in accordance with the width of the image pickup block 3 in the left-right direction. This enables a large-size cooling fan 8 to be disposed in the circuit block 4, thus allowing a sufficient volume of cooling air to be attained with the cooling fan 8 rotating at low speed. Accordingly, this can reduce noise frequency and noise level, thereby achieving noise reduction.

Although the cooling fan 8 is used as an exhaust fan in the above description, the cooling fan 8 may alternatively be used as an intake fan. In that case, the intake hole is located in the rear surface of the circuit block 4, and the exhaust hole is located in the lower surface.

Similar to the image pickup device 1, the cooling fan 8 may alternatively be disposed below the circuit substrates 7 such that the rotary shaft of the cooling fan 8 extends in the vertical direction. In that case, if the cooling fan 8 is used as an exhaust fan, the intake hole is located in the rear surface of the circuit block 4, and the exhaust hole is located in the lower surface of the circuit block 4. If the cooling fan 8 is used as an intake fan, the intake hole is located in the lower surface of the circuit block 4, and the exhaust hole is located in the rear surface of the circuit block 4.

In the case where the recording block 5 is disposed adjacently below the image pickup block 3 and the circuit block 4, the cooling fan 8 can be disposed above the circuit substrates 7 such that the rotary shaft of the cooling fan 8 extends in the vertical direction. In that case, if the cooling fan 8 is used as an exhaust fan, the intake hole is located in the rear surface of the circuit block 4, and the exhaust hole is located in the upper surface of the circuit block 4. If the cooling fan 8 is used as an intake fan, the intake hole is located in the upper surface of the circuit block 4, and the exhaust hole is located in the rear surface of the circuit block 4.

In the case where the cooling fan 8 is disposed above the circuit substrates 7 and is used as an exhaust fan in particular, the increased-temperature air in the circuit block 4 can move upward readily. Thus, the air can be discharged readily through the exhaust hole in the upper surface of the circuit block 4, thereby enhancing the cooling efficiency.

As in the image pickup devices 1A and 1B according to the first and second modified examples, the cooling fan 8, the exhaust hole, and the intake hole in the image pickup device 10 can be set at appropriate positions in accordance with the orientation of the circuit substrates 7.

For example, in a case where the circuit substrates 7 are arranged separately from each other in the front-rear direction such that the component-mount surfaces thereof are faced in the front-rear direction, if the recording block 5 is disposed adjacently above the image pickup block 3 and the circuit block 4, the cooling fan 8 will be disposed below, to the left of, or to the right of the circuit substrates 7.

On the other hand, in a case where the circuit substrates 7 are arranged separately from each other in the vertical direction such that the component-mount surfaces thereof are faced in the vertical direction, if the recording block 5 is disposed adjacently above the image pickup block 3 and the circuit block 4, the cooling fan 8 will be disposed behind, to the left of, or to the right of the circuit substrates 7.

Similar to the image pickup device 1C according to the third modified example, the image pickup device 10 can alternatively have the cooling fan 8 disposed at a forward-end portion of the circuit block 4 behind the image pickup block 3 such that the rotary shaft of the cooling fan 8 extends in the front-rear direction.

Although each of the image pickup devices 1, 1A, 1B, 1C, 10 described above has the recording block 5 disposed adjacently to the right of, to the left of, above, or below the image pickup block 3 and the circuit block 4, 4A, 4B, or 4C, the positioning of the recording block with respect to the image pickup block and the circuit block is not limited to those mentioned above. The recording block may be disposed at any position as long as the recording block is adjacent to the image pickup block and the circuit block in a direction substantially perpendicular to the direction (i.e. the front-rear direction) in which the image pickup block and the circuit block are arranged. For example, the recording block may be disposed adjacently to the upper right side, the lower right side, the upper left side, or the lower left side of the image pickup block and the circuit block.

The cooling fan 8 may be a single cooling fan or may include a plurality of small-size cooling fans. In the latter case, the small-size cooling fans can be controlled so as to selectively cool different sections of the image pickup device 1, 1A, 1B, or 1C depending on the condition of the device. Such sectional cooling control can contribute to less power consumption.

It should be understood by those skilled in the art that various modifications, combinations, sub-combinations and alterations may occur depending on design requirements and other factors insofar as they are within the scope of the appended claims or the equivalents thereof.

What is claimed is:

1. An image pickup device comprising:
a lens-barrel block having a lens barrel in which a predetermined lens is disposed;
an image pickup block having an image pickup element that converts a light signal of a subject taken in through the lens-barrel block into an image signal;
a circuit block having a circuit substrate that at least processes the image signal; and
a recording block that records the image signal,
wherein when a side of the device that is proximate to the subject is defined as a front side of the device, the image pickup block and the circuit block are arranged adjacent to each other in a front-rear direction of the device, and the recording block is disposed adjacent to the image pickup block and the circuit block in a direction substantially perpendicular to the direction in which the image pickup block and the circuit block are arranged.

2. The image pickup device according to claim 1, wherein the recording block is disposed adjacently to a left side or right side of the image pickup block and the circuit block.

3. The image pickup device according to claim 1, wherein the recording block is disposed adjacently above or below the image pickup block and the circuit block.

4. The image pickup device according to claim 1, wherein the circuit block has a cooling fan disposed therein for cooling the circuit substrate, and
wherein the cooling fan has a rotary shaft whose axial direction extends substantially perpendicular to a direction in which a component-mount surface of the circuit substrate is faced.
